(19) United States
(12) Patent Application Publication
(10) Pub. No.: US 2021/0300350 A1
(43) Pub. Date: Sep. 30, 2021

(54) VEHICLE CONTROL DEVICE, VEHICLE CONTROL METHOD, AND STORING MEDIUM

(71) Applicant: HONDA MOTOR CO., LTD., Tokyo (JP)

(72) Inventor: Yuji Yasui, Wako-shi (JP)

(21) Appl. No.: 17/213,266

(22) Filed: Mar. 26, 2021

(30) Foreign Application Priority Data
Mar. 31, 2020 (JP) 2020-063510

(51) Int. Cl. B60W 30/09; B60W 30/095; B60W 60/00

(52) U.S. Cl. CPC B60W 30/09; B60W 60/0015; B60W 30/0956

(57) ABSTRACT

A vehicle control device includes a recognizer configured to recognize an object near a vehicle, a generator configured to generate one or more target trajectories, along which the vehicle travels, on the basis of the object, and a driving controller configured to automatically control driving of the vehicle on the basis of the target trajectories. The generator calculates a travelable area, which is an area where the vehicle is able to travel, on the basis of a state of the object, and excludes a target trajectory outside the calculated travelable area from the one or more generated target trajectories, and the driving controller automatically controls the driving of the vehicle on the basis of the target trajectory that remains without being excluded by the generator.

### CROSS-REFERENCE TO RELATED APPLICATION

Priority is claimed on Japanese Patent Application No. 2020-063510, filed Mar. 31, 2020, the content of which is incorporated herein by reference.

### BACKGROUND

### Field of the Invention

The present invention relates to a vehicle control device, a vehicle control method, and a storing medium.

### Description of Related Art

A technology of generating a target trajectory to be traveled by a vehicle in the future is known (for example, see Japanese Unexamined Patent Application, First Publication No. 2019-108124).

### SUMMARY

However, in the related art, a target trajectory that does not match a surrounding situation may be generated. As a consequence, the driving of the vehicle may not be safely controlled.

The present invention is achieved in view of the problems described above, and one object of the present invention is to provide a vehicle control device, a vehicle control method, and a storing medium, by which it is possible to more safely control the driving of a vehicle.

In order to solve the above problems and achieve the above object, the present invention employs the following aspects.

The first aspect of the present invention is a vehicle control device including a recognizer configured to recognize an object near a vehicle; a generator configured to generate one or more target trajectories, along which the vehicle travels, on the basis of the object recognized by the recognizer; and a driving controller configured to automatically control driving of the vehicle on the basis of the target trajectories generated by the generator, wherein the generator calculates a travelable area, which is an area where the vehicle is able to travel, on the basis of a state of the object recognized by the recognizer, and excludes a target trajectory outside the calculated travelable area from the one or more generated target trajectories, and the driving controller automatically controls the driving of the vehicle on the basis of the target trajectory that remains without being excluded by the generator.

According to the second aspect, in the first aspect, the vehicle control device may further include a calculator configured to calculate a risk area which is an area of risk distributed around the object recognized by the recognizer, wherein the generator may input the risk area calculated by the calculator to a model that determines the target trajectory according to the risk area, and generate the one or more target trajectories on the basis of an output result of the model to which the risk area is input.

According to the third aspect, in the second aspect, the model may be a machine learning-based first model learned to output the target trajectory when the risk area is input.

According to the fourth aspect, in any one of the first to third aspects, the generator may calculate the travelable area by using a rule-based or model-based second model that determines the travelable area according to the state of the object.

According to the fifth aspect, in any one of the first to fourth aspects, the generator may select an optimal target trajectory from the one or more target trajectories from which the target trajectory outside the travelable area is excluded, and the driving controller may automatically control the driving of the vehicle on the basis of the optimal target trajectory selected by the generator.

The sixth aspect is a vehicle control method implemented by a computer mounted in a vehicle and including steps of: recognizing an object near a vehicle; generating one or more target trajectories, along which the vehicle travels, on the basis of the recognized object; automatically controlling driving of the vehicle on the basis of the generated target trajectories; calculating a travelable area, which is an area where the vehicle is able to travel, on the basis of a state of the recognized object; excluding a target trajectory outside the calculated travelable area from the one or more generated target trajectories; and automatically controlling the driving of the vehicle on the basis of the target trajectory that remains without being excluded.

The seventh aspect is a non-transitory computer readable storing medium storing a program causing a computer mounted in a vehicle to perform: recognizing an object near a vehicle; generating one or more target trajectories, along which the vehicle travels, on the basis of the recognized object; automatically controlling driving of the vehicle on the basis of the generated target trajectories; calculating a travelable area, which is an area where the vehicle is able to travel, on the basis of a state of the recognized object; excluding a target trajectory outside the calculated travelable area from the one or more generated target trajectories; and automatically controlling the driving of the vehicle on the basis of the target trajectory that remains without being excluded.

According to any of the above aspects, it is possible to more safely control the driving of a vehicle.

### BRIEF DESCRIPTION OF THE DRAWINGS

FIG. 1 is a configuration diagram of a vehicle system using a vehicle control device according to an embodiment.

FIG. 2 is a functional configuration diagram of a first controller, a second controller, and a storage according to the embodiment.

FIG. 3 is a diagram for explaining a risk area.

FIG. 4 is a diagram showing a change in a risk potential in a Y direction at a certain coordinate x1.

FIG. 5 is a diagram showing a change in the risk potential in the Y direction at a certain coordinate x2.

FIG. 6 is a diagram showing a change in the risk potential in the Y direction at a certain coordinate x3.

FIG. 7 is a diagram showing a change in the risk potential in an X direction at a certain coordinate x4.

FIG. 8 is a diagram showing the risk area where the risk potential is determined.

FIG. 9 is a diagram schematically showing a method of generating a target trajectory.

FIG. 10 is a diagram showing an example of a target trajectory output by a certain DNN model.

FIG. 11 is a flowchart showing an example of the flow of a series of processes by an automated driving control device according to the embodiment.

FIG. 12 is a diagram showing an example of a situation that a host vehicle may encounter.

FIG. 13 is a diagram showing an example of a plurality of target trajectories.

FIG. 14 is a diagram showing an example of excluded target trajectories.

FIG. 15 is a diagram showing an example of a situation in which at least one of the speed and steering of the host vehicle is controlled on the basis of a target trajectory.

FIG. 16 is a diagram showing another example of a situation that the host vehicle may encounter.

FIG. 17 is a diagram showing another example of the plurality of target trajectories.

FIG. 18 is a diagram showing another example of excluded target trajectories.

FIG. 19 is a diagram showing another example of a situation in which at least one of the speed and steering of the host vehicle is controlled on the basis of a target trajectory.

FIG. 20 is a diagram showing an example of a hardware configuration of the automated driving control device of the embodiment.

### DESCRIPTION OF EMBODIMENTS

Hereinafter, embodiments of a vehicle control device, a vehicle control method, and a storing medium of the present invention will be described with reference to the drawings. The vehicle control device of the embodiment is applied to, for example, an automated driving vehicle. Automated driving is, for example, to control the driving of a vehicle by controlling one or both of the speed and steering thereof. The aforementioned vehicle driving control includes, for example, various types of driving control such as adaptive cruise control system (ACC), traffic jam pilot (TJP), auto lane changing (ALC), collision mitigation brake system (CMBS), and lane keeping assistance system (LKAS). The driving of the automated driving vehicle may be controlled by manual driving of an occupant (driver).

[Overall Configuration]

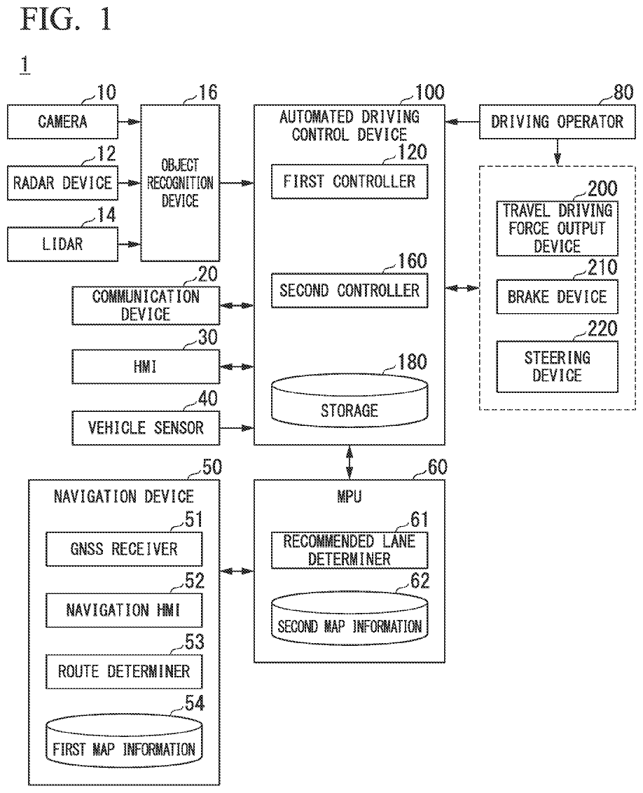

FIG. 1 is a configuration diagram of a vehicle system 1 using the vehicle control device according to the embodiment. A vehicle (hereinafter, referred to as a host vehicle M), in which the vehicle system 1 is installed, is a vehicle with two wheels, three wheels, four wheels and the like, for example, and its driving source is an internal combustion engine such as a diesel engine and a gasoline engine, an electric motor, or a combination thereof. The electric motor operates by using power generated by a generator connected to the internal combustion engine or power discharged from a secondary cell or a fuel cell.

The vehicle system 1 includes, for example, a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driving operator 80, an automated driving control device 100, a travel driving force output device 200, a brake device 210, and a steering device 220. These devices and equipment are connected to one another via a multiplex communication line such as a controller area network (CAN) communication line, a serial communication line, a wireless communication network, and the like. The configuration shown in FIG. 1 is merely an example, and a part of the configuration may be omitted, or other configurations may be added. The automated driving control device 100 is an example of the “vehicle control device.”

The camera 10 is, for example, a digital camera using a solid-state imaging element such as a charge coupled device (CCD) and a complementary metal oxide semiconductor (CMOS). The camera 10 is mounted at arbitrary places on the host vehicle M. For example, in the case of capturing an image of an area in front of the host vehicle M, the camera 10 is mounted on an upper part of a front windshield, on a rear surface of a rear-view mirror, and the like. In the case of capturing an image of an area behind the host vehicle M, the camera 10 is mounted on an upper part of a rear windshield, and the like. In the case of capturing an image of an area on the right side or the left side of the host vehicle M, the camera 10 is mounted on the right side surface or the left side surface of a vehicle boy or a side mirror. The camera 10, for example, periodically and repeatedly captures the surroundings of the host vehicle M. The camera 10 may be a stereo camera.

The radar device 12 emits radio waves such as millimeter waves to the surroundings of the host vehicle M, detects radio waves (reflected waves) reflected by an object, and detects at least a position (a distance and an orientation) of the object. The radar device 12 is mounted at arbitrary places on the host vehicle M. The radar device 12 may detect the position and the speed of the object by a frequency modulated continuous wave (FM-CW) scheme.

The LIDAR 14 emits light to the surroundings of the host vehicle M and measures scattered light of the emitted light. The LIDAR 14 detects a distance to a target on the basis of a time from light emission to light reception. The emitted light may be a pulsed laser beam, for example. The LIDAR 14 is mounted at arbitrary places on the host vehicle M.

The object recognition device 16 performs a sensor fusion process on results of detection by some or all of the camera 10, the radar device 12, and the LIDAR 14, thereby recognizing the position, the type, the speed and the like of an object. The object recognition device 16 outputs a recognition result to the automated driving control device 100. The object recognition device 16 may output the detection results of the camera 10, the radar device 12, and the LIDAR 14 to the automated driving control device 100 as they are. In such a case, the object recognition device 16 may be omitted from the vehicle system 1.

The communication device 20 communicates with other vehicles near the host vehicle M, or communicates with various server devices via a wireless base station by using, for example, a cellular network, a Wi-Fi network, Bluetooth (registered trademark), dedicated short range communication (DSRC), and the like.

The HMI 30 presents various types of information to an occupant (including a driver) of the host vehicle M and receives an input operation of the occupant. The HMI 30 may include, for example, a display, a speaker, a buzzer, a touch panel, a microphone, a switch, a key, and the like.

The vehicle sensor 40 includes a vehicle speed sensor that detects the speed of the host vehicle M, an acceleration sensor that detects acceleration, a yaw rate sensor that detects an angular velocity around a vertical axis, a direction sensor that detects the direction of the host vehicle M, and the like.

The navigation device 50 includes, for example, a global navigation satellite system (GNSS) receiver 51, a navigation HMI 52, and a route determiner 53. The navigation device 50 stores first map information 54 in a storage device such as a hard disk drive (HDD) and a flash memory.

The GNSS receiver 51 specifies the position of the host vehicle M on the basis of a signal received from a GNSS satellite. The position of the host vehicle M may be specified or complemented by an inertial navigation system (INS) using the output of the vehicle sensor 40.

The navigation HMI 52 includes a display device, a speaker, a touch panel, keys, and the like. The navigation HMI 52 may be partially or entirely shared with the aforementioned HMI 30. For example, the occupant may input a destination of the host vehicle M to the navigation HMI 52, in place of or in addition to inputting the destination of the host vehicle M to the HMI 30.

The route determiner 53 determines, for example, a route (hereinafter, referred to as a route on a map) to a destination, which is input by the occupant using the HMI 30 or the navigation HMI 52, from the position of the host vehicle M specified by the GNSS receiver 51 (or any input position) with reference to the first map information 54.

The first map information 54 is, for example, information in which a road shape is expressed by links indicating a road and nodes connected by the links. The first map information 54 may include a road curvature, point of interest (POI) information, and the like. The route on the map is output to the MPU 60.

The navigation device 50 may provide route guidance using the navigation HMI 52 on the basis of the route on the map. The navigation device 50 may be implemented by, for example, functions of a terminal device such as a smart phone and a tablet terminal owned by the occupant. The navigation device 50 may transmit the current position and the destination to a navigation server via the communication device 20, and acquire a route equivalent to the route on the map from the navigation server.

The MPU 60 includes, for example, a recommended lane determiner 61 and stores second map information 62 in a storage device such as an HDD and a flash memory. The recommended lane determiner 61 divides the route on the map provided from the navigation device 50 into a plurality of blocks (for example, divides the route on the map every 100 m in the vehicle travel direction), and determines a recommended lane for each block with reference to the second map information 62. The recommended lane determiner 61 determines which lane to travel from the left. When there is a branch point on the route on the map, the recommended lane determiner 61 determines a recommended lane such that the host vehicle M can travel on a reasonable route for traveling to a branch destination.

The second map information 62 is more accurate map information than the first map information 54. The second map information 62 includes, for example, information on the center of a lane, information on the boundary of the lane, and the like. The second map information 62 may include road information, traffic regulation information, address information (address and postal code), facility information, telephone number information, and the like. The second map information 62 may be updated at any time by the communication device 20 communicating with another device.

The driving operator 80 includes, for example, an accelerator pedal, a brake pedal, a shift lever, a steering wheel, a deformed steer, a joy stick, and other operators. The driving operator 80 is provided with a sensor for detecting an operation amount or the presence or absence of an operation attached thereto, and its detection result is output to the automated driving control device 100, or some or all of the travel driving force output device 200, the brake device 210, and the steering device 220.

The automated driving control device 100 includes, for example, a first controller 120, a second controller 160, and a storage 180. Each of the first controller 120 and the second controller 160 is implemented by, for example, a hardware processor, such as a central processing unit (CPU) and a graphics processing unit (GPU) executing a program (software). Some or all of these components may be implemented by hardware (a circuit unit: including circuitry) such as a large scale integration (LSI), an application specific integrated circuit (ASIC), and a field-programmable gate array (FPGA), or may be implemented by software and hardware in cooperation. The program may be stored in advance in a storage device (storage device including a non-transitory storage medium) such as an HDD and a flash memory of the automated driving control device 100, or may be installed in the HDD and the flash memory of the automated driving control device 100 when a detachable storage medium (non-transitory storage medium) storing the program, such as a DVD and a CD-ROM, is mounted on a drive device.

The storage 180 is implemented by the aforementioned each storage device.

The storage 180 is implemented by, for example, an HDD, a flash memory, an electrically erasable programmable read only memory (EEPROM), a read only memory (ROM), a random access memory (RAM), and the like. The storage 180 stores, for example, rule-based model data 182, a deep neural network(s) (DNN) model data 184, and the like, in addition to the program read and executed by the processor. Details of the rule-based model data 182 and the DNN model data 184 will be described below.

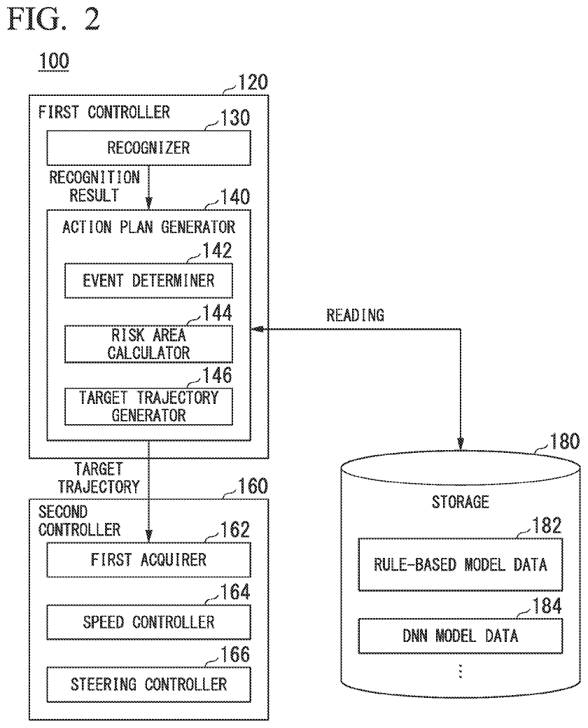

FIG. 2 is a functional configuration diagram of the first controller 120, the second controller 160, and the storage 180. The first controller 120 includes, for example, a recognizer 130 and an action plan generator 140.

The first controller 120 performs, for example, a function based on an artificial intelligence (AI) and a function based on a predetermined model in parallel. For example, a function of “recognizing an intersection” may be implemented by performing intersection recognition by deep learning and the like and recognition based on a predetermined condition (pattern matching signals, road markings, and the like) in parallel, or scoring both recognition and comprehensively evaluating them. In this way, the reliability of automated driving is ensured.

The recognizer 130 recognizes the situation or environment around the host vehicle M. For example, the recognizer 130 recognizes objects near the host vehicle M on the basis of information input from the camera 10, the radar device 12, and the LIDAR 14 via the object recognition device 16. The objects recognized by the recognizer 130 include, for example, bicycles, motorcycles, four-wheel vehicles, pedestrians, road signs, road markings, marking lines, electric poles, guardrails, falling objects, and the like. The recognizer 130 recognizes a state such as the position, speed, acceleration, and the like of the object. The position of the object is recognized as, for example, a position on relative coordinates (that is, a relative position with respect to the host vehicle M) with a representative point (center of gravity, the center of the drive axis, and the like) of the host vehicle M as the origin, and is used for control. The position of the object may be represented by a representative point of the center of gravity, a corner, and the like of the object, or may be represented by an indicated area. The “state” of the object may include an acceleration, a jerk, or an “action state” (for example, whether a lane change is being performed or is intended to be performed) of the object.

The recognizer 130 recognizes, for example, a lane in which the host vehicle M is traveling (hereinafter, a host lane), an adjacent lane adjacent to the host lane, and the like. For example, the recognizer 130 compares a pattern (for example, an arrangement of solid lines and broken lines) of road marking lines obtained from the second map information 62 with a pattern of road marking lines around the host vehicle M, which is recognized from the image captured by the camera 10, thereby recognizing a space between the road marking lines as the host lane or the adjacent lane.

The recognizer 130 may recognize lanes such as the host lane and the adjacent lane by recognizing not only the road marking lines but also a traveling road boundary (road boundary) including the road marking lines, road shoulders, curbs, median strips, guardrails, and the like. In this recognition, the position of the host vehicle M acquired from the navigation device 50 or a processing result of the INS may be taken into consideration. The recognizer 130 may recognize temporary stop lines, obstacles, red lights, tollgates, and other road events.

When recognizing the host lane, the recognizer 130 recognizes the relative position and the orientation of the host vehicle M with respect to the host lane. The recognizer 130, for example, may recognize, as the relative position and the orientation of the host vehicle M with respect to the host lane, a deviation of a reference point of the host vehicle M from a center of a lane and an angle formed with respect to a line connecting the center of the lane in the travel direction of the host vehicle M. Instead of this, the recognizer 130 may recognize the position and the like of the reference point of the host vehicle M with respect to any one of the side ends (the road marking line or the road boundary) of the host lane as the relative position of the host vehicle M with respect to the host lane.

The action plan generator 140 includes, for example, an event determiner 142, a risk area calculator 144, and a target trajectory generator 146.

When the host vehicle M is under automated driving on a route where the recommended lane has been determined, the event determiner 142 determines travel modes of the automated driving. Hereinafter, information that defines the travel modes of the automated driving will be described as events.

The events include, for example, constant speed travel events, following travel events, lane change events, branching events, merging events, takeover events, and the like. The constant speed travel event is a travel mode in which the host vehicle M travels in the same lane at a constant speed. The following travel event is a travel mode in which the host vehicle M is made to follow another vehicle (hereinafter, referred to as a preceding vehicle) existing within a predetermined distance (for example, within 100 [m]) in front of the host vehicle M on the host lane and closest to the host vehicle M.

The “following” may be, for example, a travel mode in which a distance (relative distance) between the host vehicle M and the preceding vehicle is kept constant, or a travel mode in which the host vehicle M is made to travel in the center of the host lane in addition to keeping the distance between the host vehicle M and the preceding vehicle constant.

The lane change event is a travel mode in which the lane of the host vehicle M is changed from the host lane to the adjacent lane. The branching event is a travel mode in which the host vehicle M is made to travel in a lane on a destination side at a branching point of a road. The merging event is a travel mode in which the host vehicle M is made to merge into a main lane at a merging point. The takeover event is a travel mode in which automated driving is ended and switched to manual driving.

The events may include, for example, overtaking events, avoidance events, and the like. The overtaking event is a travel mode in which the host vehicle M is made to temporarily change the host lane to the adjacent lane, overtake the preceding vehicle in the adjacent lane, and then return to the original lane again. The avoidance event is a travel mode in which the host vehicle M is made to perform at least one of braking and steering in order to avoid an obstacle existing in front of the host vehicle M.

For example, the event determiner 142 may change an event already determined for the current section to another event or determine a new event for the current section according to the surrounding situation recognized by the recognizer 130 during the travel of the host vehicle M.

The risk area calculator 144 calculates an area of a risk (hereinafter, referred to as a risk area RA) that is potentially distributed or potentially exists around the object recognized by the recognizer 130. The risk is, for example, a risk that the object poses to the host vehicle M. More specifically, the risk may be a risk of forcing the host vehicle M to brake suddenly because the preceding vehicle suddenly decelerates or another vehicle cuts in front of the host vehicle M from the adjacent lane, or a risk of forcing the host vehicle M to steer suddenly because a pedestrian or a bicycle enters the roadway. The risk may be a risk that the host vehicle M poses to an object. Hereinafter, it is assumed that the degree of the risk is treated as a quantitative index value, and the index value will be described as “risk potential p.”

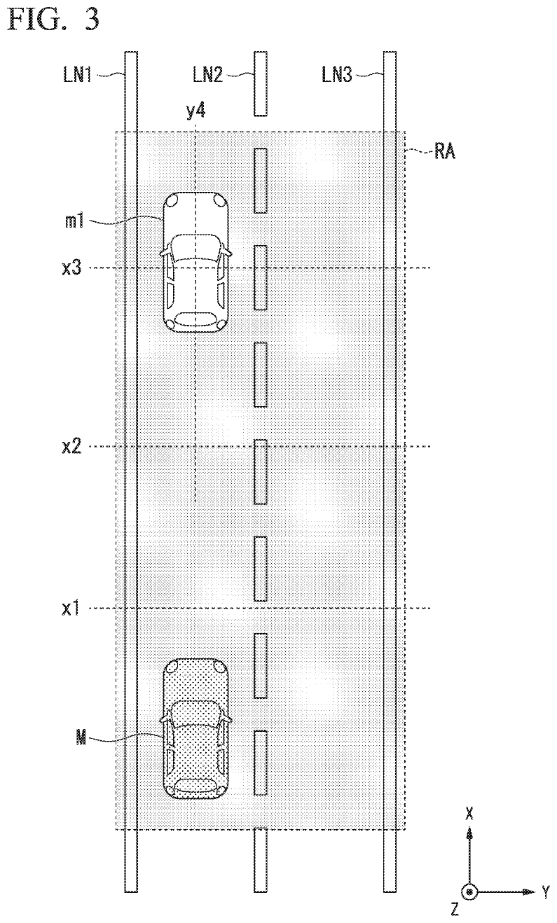

FIG. 3 is a diagram for explaining the risk area RA. In FIG. 3, LN1 represents one section line for partitioning the host lane, and LN2 represents the other section line for partitioning the host lane and represents one section line for partitioning the adjacent lane. LN3 represents the other section line for partitioning the adjacent lane. Among the plurality of section lines, the LN1 and LN3 are roadside lines and LN2 is a central line where vehicles are allowed to stick out in order to overtake preceding vehicles. In the shown example, a preceding vehicle m1 exists in front of the host vehicle M on the host lane. In FIG. 3, X represents the travel direction of a vehicle, Y represents the width direction of a vehicle, and Z represents the vertical direction.

In the case of the shown situation, the risk area calculator 144 increases the risk potential p as an area is closer to the roadside lines LN1 and LN3 and decreases the risk potential p as an area is farther from the roadside lines LN1 and LN3, in the risk area RA.

The risk area calculator 144 increases the risk potential p as an area is closer to the central line LN2 and decreases the risk potential p as an area is farther from the central line LN2, in the risk area RA. Unlike the roadside lines LN1 and LN3, since vehicles are allowed to stick out in the central line LN2, the risk area calculator 144 sets the risk potential p for the central line LN2 to be lower than the risk potential p for the roadside lines LN1 and LN3.

The risk area calculator 144 increases the risk potential p as an area is closer to the preceding vehicle m1, which is a kind of an object, and decreases the risk potential p as an area is farther from the preceding vehicle m1, in the risk area RA. That is, the risk area calculator 144 may increase the risk potential p as the relative distance between the host vehicle M and the preceding vehicle m1 is shorter, and decrease the risk potential p as the relative distance between the host vehicle M and the preceding vehicle m1 is longer, in the risk area RA. In such a case, the risk area calculator 144 may increase the risk potential p as the absolute speed or absolute acceleration of the preceding vehicle m1 increases. The risk potential p may be appropriately determined according to the relative speed or relative acceleration between the host vehicle M and the preceding vehicle m1, time to collision (TTC), and the like, in place of or in addition to the absolute speed or absolute acceleration of the preceding vehicle m1.

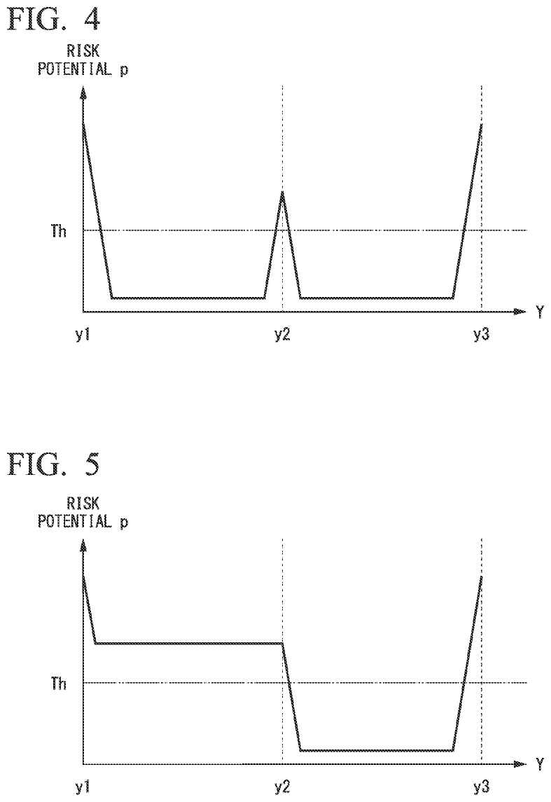

FIG. 4 is a diagram showing a change in the risk potential p in the Y direction at a certain coordinate x1. In FIG. 4, y1 represents the position (coordinates) of the roadside line LN1 with respect to the Y direction, y2 represents the position (coordinates) of the central line LN2 with respect to the Y direction, and y3 represents the position (coordinates) of the roadside line LN3 with respect to the Y direction.

As shown in FIG. 4, the risk potential p is the highest in the vicinity of the coordinates (x1, y1) where the roadside line LN1 is and in the vicinity of the coordinates (x1, y3) where the roadside line LN3 is, and the risk potential p is second highest after the coordinates (x1, y1) and (x1, y3) in the vicinity of the coordinates (x1, y2) where the central line LN2 is. As will be described below, since a vehicle is prevented from entering an area where the risk potential p is equal to or larger than a predetermined threshold value Th, a target trajectory TR is not generated.

FIG. 5 is a diagram showing a change in the risk potential p in the Y direction at a certain coordinate x2. The coordinate x2 is closer to the preceding vehicle m1 than the coordinate x1. Therefore, the preceding vehicle m1 is not in an area between the coordinates (x2, y1) where the roadside line LN1 is and the coordinates (x2, y2) where the central line LN2 is, but risks such as sudden deceleration of the preceding vehicle m1 are taken into consideration. As a consequence, the risk potential p in the area between (x2, y1) and (x2, y2) tends to be higher than the risk potential p in the area between (x1, y1) and (x1, y2), and is, for example, equal to or more than the threshold value Th.

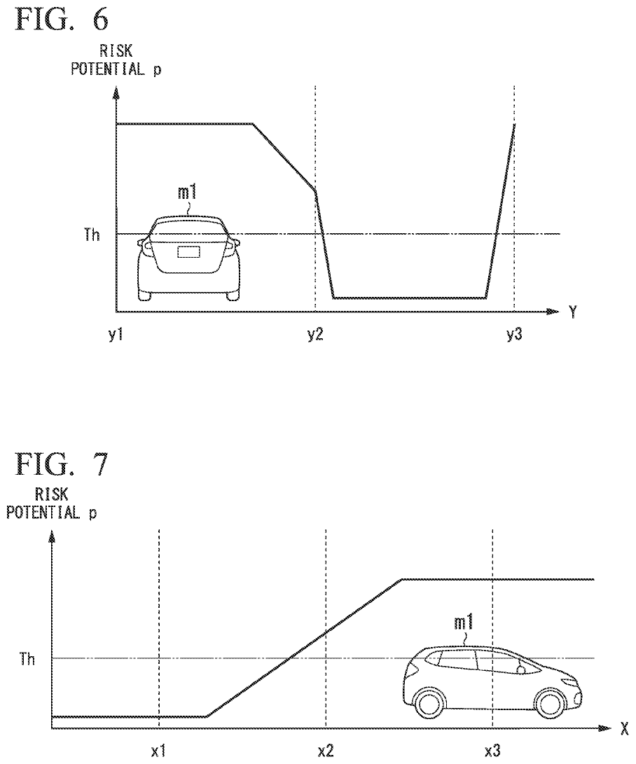

FIG. 6 is a diagram showing a change in the risk potential p in the Y direction at a certain coordinate x3. The preceding vehicle m1 is at the coordinate x3. Therefore, the risk potential p in the area between the coordinates (x3, y1) where the roadside line LN1 is and the coordinates (x3, y2) where the central line LN2 is, is higher than the risk potential p in the area between (x2, y1) and (x2, y2), and is equal to or more than the threshold value Th.

FIG. 7 is a diagram showing a change in the risk potential p in an X direction at a certain coordinate x4. The coordinate x4 is an intermediate coordinate between y1 and y2 and the preceding vehicle m1 is at the coordinate x4. Therefore, the risk potential p at the coordinates (x3, y4) is the highest, the risk potential p at the coordinates (x2, y4) farther from the preceding vehicle m1 than the coordinates (x3, y4) is lower than the risk potential p at the coordinates (x3, y4), and the risk potential p at the coordinates (x1, y4) farther from the preceding vehicle m1 than the coordinates (x2, y4) is lower than the risk potential p at the coordinates (x2, y4).

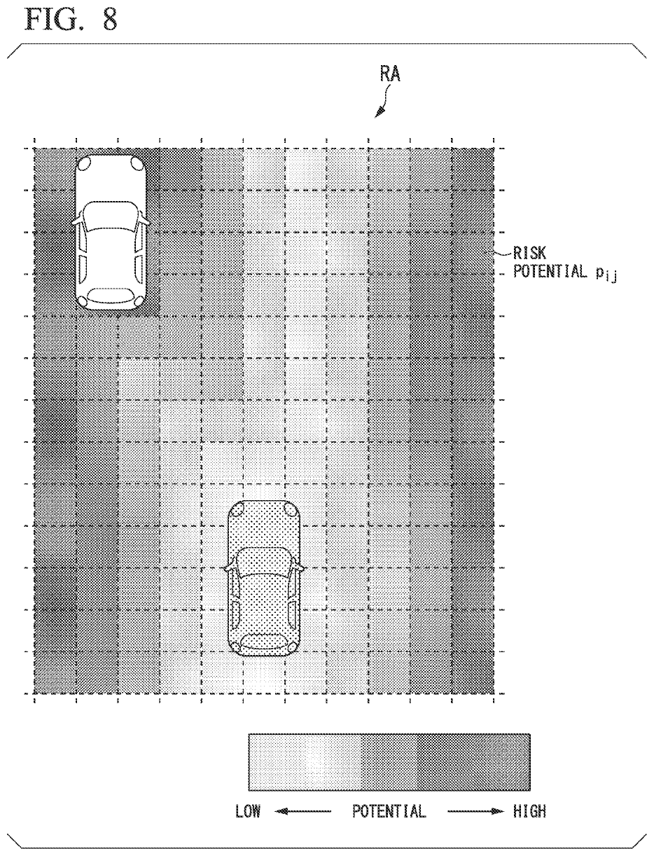

FIG. 8 is a diagram showing the risk area RA where the risk potential p is determined. As shown in FIG. 8, the risk area calculator 144 divides the risk area RA into a plurality of meshes (also referred to as grids), and correlates the risk potential p with each of the plurality of meshes. For example, the mesh (xᵢ, yⱼ) is correlated with the risk potential pᵢⱼ. That is, the risk area RA is represented by a data structure such as a vector and a tensor.

When the risk potential p is correlated with the plurality of meshes, the risk area calculator 144 normalizes the risk potential p of each mesh.

For example, the risk area calculator 144 may normalize the risk potential p such that the risk potential p has a maximum value of 1 and a minimum value of 0. Specifically, the risk area calculator 144 selects the risk potential pₘₐₓ having the maximum value and the risk potential pₘᵢₙ having the minimum value from the risk potential p of all the meshes included in the risk area RA. The risk area calculator 144 selects one target mesh (xᵢ, yᵢ) from all the meshes included in the risk area RA, subtracts the minimum risk potential pₘᵢₙ from the risk potential pᵢⱼ correlated with the mesh (xᵢ, yᵢ), subtracts the minimum risk potential pₘᵢₙ from the maximum risk potential pₘₐₓ, and divides (pᵢⱼ-pₘᵢₙ) by (pₘₐₓ−pₘᵢₙ). The risk area calculator 144 repeats the above process while changing a target mesh. In this way, the risk area RA is normalized such that the risk potential p has a maximum value of 1 and a minimum value of 0.

The risk area calculator 144 may calculate an average value μ and a standard deviation σ of the risk potential p of all the meshes included in the risk area RA, subtract the average value μ from the risk potential pᵢⱼ correlated with the mesh (xᵢ, yⱼ), and divide (pᵢⱼ−μ) by the standard deviation σ. In this way, the risk area RA is normalized such that the risk potential p has a maximum value of 1 and a minimum value of 0.

The risk area calculator 144 may normalize the risk area RA such that the risk potential p has an arbitrary maximum value of M and an arbitrary minimum value of m. Specifically, when (pᵢⱼ−pₘᵢₙ)/(pₘₐₓ−pₘᵢₙ) is referred to as A, the risk area calculator 144 multiplies A by (M−m) and adds m to A(M−m). In this way, the risk area RA is normalized such that the risk potential p has a maximum value of M and a minimum value of m.

Returning to FIG. 2, the target trajectory generator 146 generates a future target trajectory TR along which the host vehicle M will travel in the travel modes defined by the events automatically (independent of a driver's operation) to allow the host vehicle M to travel in the recommended lane determined by the recommended lane determiner 61 in principle and further to cope with a surrounding situation while the host vehicle M is traveling in the recommended lane. The target trajectory TR includes, for example, a position element that defines the future position of the host vehicle M and a speed element that defines the future speed and the like of the host vehicle M.

For example, the target trajectory generator 146 determines, as the position element of the target trajectory TR, a plurality of points (trajectory points) to be reached in sequence by the host vehicle M. The trajectory points are points that the host vehicle M should reach for each predetermined travel distance (for example, about every several [m]). The predetermined travel distance may be calculated by, for example, a distance along a road when traveling along a route.

For example, the target trajectory generator 146 determines a target speed v and a target acceleration α at each predetermined sampling time (for example, about every several tenths of a [sec]) as the speed element of the target trajectory TR. Furthermore, the trajectory point at each predetermined sampling time may be a position that the host vehicle M will reach at each sampling time. In such a case, the target speed v and the target acceleration α are determined by the sampling time and the interval between the trajectory points.

For example, the target trajectory generator 146 reads the rule-based model data 182 from the storage 180, and calculates an area where the host vehicle M can travel (hereinafter, referred to as a travelable area DA) by using a model defined by the data. Moreover, the target trajectory generator 146 reads the DNN model data 184 from the storage 180, and generates one or more target trajectories TR by using a model defined by the data. Then, the target trajectory generator 146 excludes target trajectories TR outside the travelable area DA from the one or more generated target trajectories TR, and leaves target trajectories TR inside the travelable area DA.

The rule-based model data 182 is information (a program or data structure) that defines one or more rule-based models MDL1. The rule-based model MDL1 is a model that derives the travelable area DA from objects (including marking lines and the like) around the host vehicle M on the basis of a rule group predetermined by an expert and the like. Such a rule-based model MDL1 is also called an expert system because the expert and the like determine the rule group. The rule-based model MDL1 is an example of a “second model.”

The rule group includes laws and regulations such as road traffic laws, customs, and the like. For example, under the rule that the roadside line is a solid white line and the central line is a solid yellow line on a road with one lane on each side, the travelable area DA is an area between the roadside line and the central line. That is, only one lane is the travelable area DA. For example, under the rule that the roadside line is a solid white line and the central line is a broken white line on a road with one lane on each side, the travelable area DA is an area between one roadside line and the other roadside line. That is, two lanes also including an opposite lane are the travelable area DA. In this way, the travelable area DA is an area conforming to laws, regulations, customs, and the like.

For example, the target trajectory generator 146 inputs, to the rule-based model MDL1, a recognition result of the recognizer 130 that the roadside line is a solid white line and the central line is a solid yellow line. In such a case, the rule-based model MDL1 outputs the area (area with one lane) between the roadside line and the central line as the travelable area DA according to the aforementioned rule determined in advance.

The rule group may include a rule that defines the states of other type of objects different from the marking lines. For example, the rule group may include a rule that pedestrians, bicycles and the like outside the roadway are heading inside the roadway at speeds and accelerations equal to or more than a certain threshold value, or a rule that other vehicles are in an opposite lane. Under such rules, the travelable area DA is an area spaced a certain distance from the objects, such as pedestrians and opposite vehicles, in order to avoid the objects.

The DNN model data 184 is information (a program or data structure) that defines one or more DNN models MDL2. The DNN model MDL2 is a deep learning model learned to output the target trajectory TR when the risk area RA is input. Specifically, the DNN model MDL2 may be a convolutional neural network (CNN), a recurrent neural network (RNN), or a combination thereof. The DNN model data 184 includes, for example, various information such as coupling information regarding how units included in each of a plurality of layers constituting a neural network are coupled to one another, and a coupling coefficient given to data input/output between the coupled units. The DNN model MDL2 is an example of a “first model.”

The coupling information includes information such as the number of units included in each layer, information that designates the type of unit to which each unit is coupled, an activation function of each unit, and a gate provided between units of a hidden layer. The activation function may be, for example, a rectified linear function (ReLU function), a sigmoid function, a step function, another function, and the like. The gate allows data transferred between the units to selectively pass therethrough or weights the data according to a value (for example, 1 or 0) returned by the activation function, for example. The coupling coefficient includes, for example, a weighting coefficient given to output data when the data is output from a unit of a certain layer to a unit of a deeper layer in the hidden layer of the neural network. The coupling coefficient may include a bias component and the like unique to each layer.

The DNN model MDL2 is sufficiently learned on the basis of teaching data, for example. The teaching data is, for example, a data set in which a correct target trajectory TR to be output by the DNN model MDL2 is correlated with the risk area RA as a teaching label (also referred to as a target). That is, the teaching data is a data set in which the risk area RA as input data and the target trajectory TR as output data are combined. The correct target trajectory TR may be, for example, a target trajectory that passes a mesh, which has a risk potential p smaller than the threshold value Th and has the lowest risk potential p, among the plurality of meshes included in the risk area RA. The correct target trajectory TR may be, for example, a trajectory of a vehicle actually driven by a driver in a certain risk area RA.

The target trajectory generator 146 inputs the risk area RA calculated by the risk area calculator 144 to each of the plurality of DNN models MDL2, and generates one or more target trajectories TR on the basis of an output result of each DNN model MDL2 to which the risk area RA is input.

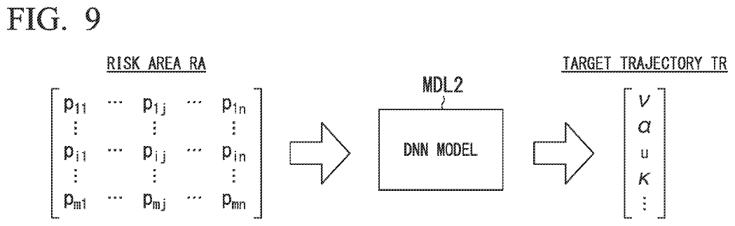

FIG. 9 is a diagram schematically showing a method of generating the target trajectory TR. For example, the target trajectory generator 146 inputs a vector or a tensor, which represents the risk area RA, to each of the plurality of DNN models MDL2. In the shown example, the risk area RA is represented as a second order tensor of m rows×n columns Each DNN model MDL2, to which the vector or the tensor representing the risk area RA is input, outputs one target trajectory TR. This target trajectory TR is, for example, represented by a vector or a tensor including a plurality of elements such as the target speed v, the target acceleration α, a steering displacement u, and a curvature κ of the trajectory.

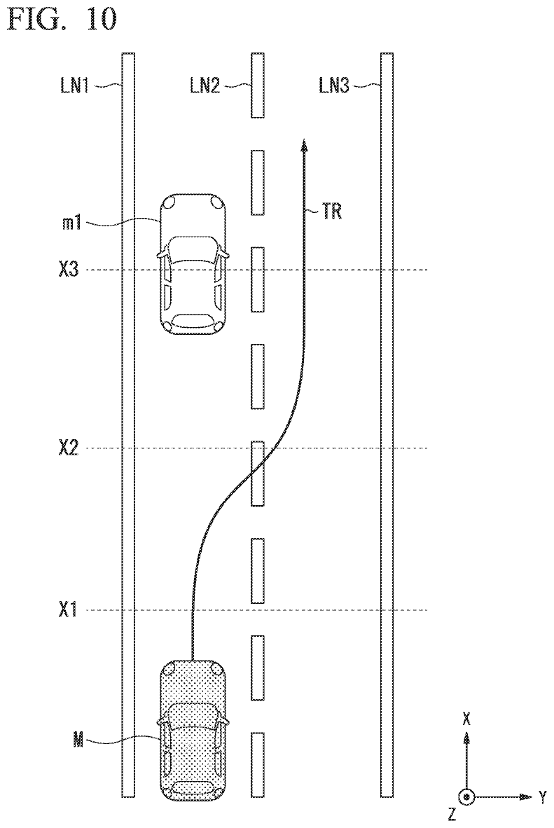

FIG. 10 is a diagram showing an example of the target trajectory TR output by a certain DNN model DL2. As shown in the example, since the risk potential p around the preceding vehicle m1 is high, the target trajectory TR is generated in order to avoid the risk potential. As a consequence, the host vehicle M changes its own lane to the adjacent lane partitioned by the marking lines LN2 and LN3 and passes the preceding vehicle m1.

Returning to FIG. 2, the second controller 160 controls the travel driving force output device 200, the brake device 210, and the steering device 220 such that the host vehicle M passes through the target trajectory TR generated by the target trajectory generator 146 at scheduled times. The second controller 160 includes, for example, a first acquirer 162, a speed controller 164, and a steering controller 166. The second controller 160 is an example of a “driving controller.”

The first acquirer 162 acquires the target trajectory TR from the target trajectory generator 146 and stores the target trajectory TR in a memory of the storage 180.

The speed controller 164 controls one or both of the travel driving force output device 200 and the brake device 210 on the basis of the speed element (for example, the target speed v, the target acceleration α, and the like) included in the target trajectory TR stored in the memory.

The steering controller 166 controls the steering device 220 according to the position element (for example, the curvature κ of the target trajectory, the steering displacement u according to the position of a trajectory point, and the like) included in the target trajectory stored in the memory.

The processes of the speed controller 164 and the steering controller 166 are implemented by, for example, a combination of feedforward control and feedback control. As an example, the steering controller 166 performs a combination of feedforward control according to the curvature of a road in front of the host vehicle M and feedback control based on a deviation from the target trajectory TR.

The travel driving force output device 200 outputs a travel driving force (torque) for driving the vehicle to driving wheels. The travel driving force output device 200 includes, for example, a combination of an internal combustion engine, an electric motor, a transmission and the like, and a power electronic control unit (ECU) for controlling them. The power ECU controls the aforementioned configuration according to information input from the second controller 160 or information input from the driving operator 80.

The brake device 210 includes, for example, a brake caliper, a cylinder for transferring hydraulic pressure to the brake caliper, an electric motor for generating the hydraulic pressure in the cylinder, and a brake ECU. The brake ECU controls the electric motor according to the information input from the second controller 160 or the information input from the driving operator 80, thereby allowing a brake torque corresponding to a brake operation to be output to each wheel. The brake device 210 may have a backup mechanism for transferring the hydraulic pressure generated by an operation of the brake pedal included in the driving operator 80 to the cylinder via a master cylinder. The brake device 210 is not limited to the aforementioned configuration and may be an electronically controlled hydraulic pressure brake device that controls an actuator according to the information input from the second controller 160, thereby transferring the hydraulic pressure of the master cylinder to the cylinder.

The steering device 220 includes, for example, a steering ECU and an electric motor. The electric motor, for example, changes a direction of a steering wheel by allowing a force to act on a rack and pinion mechanism. The steering ECU drives the electric motor according to the information input from the second controller 160 or the information input from the driving operator 80, thereby changing the direction of the steering wheel.

[Processing Flow]

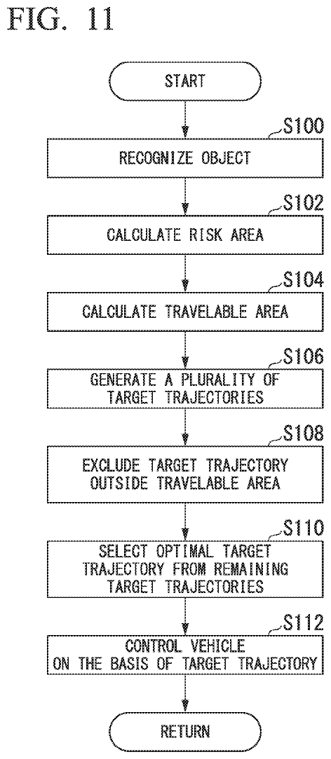

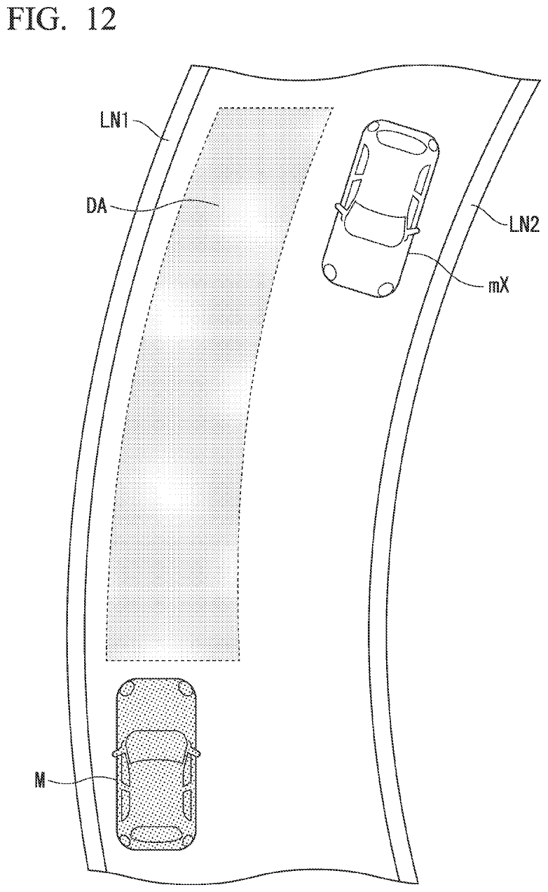

Hereinafter, the flow of a series of processes by the automated driving control device 100 according to the embodiment will be described with reference to a flowchart. FIG. 11 is a flowchart showing an example of the flow of a series of processes by the automated driving control device 100 according to the embodiment. The procedure of the present flowchart may be repeatedly performed at a predetermined cycle, for example.

First, the recognizer 130 recognizes objects existing in a road on which the host vehicle M is traveling (step S100). The objects may be various objects such as marking lines on the road, pedestrians, and opposite vehicles as described above.

Next, the risk area calculator 144 calculates the risk area RA on the basis of the positions and type of the marking lines, the positions, speeds, and directions of other surrounding vehicles, and the like (step S102).

For example, the risk area calculator 144 divides a predetermined range into a plurality of meshes and calculates the risk potential p for each of the plurality of meshes. Then, the risk area calculator 144 calculates, as the risk area RA, a vector or a tensor in which the risk potential p is correlated with each mesh. In such a case, the risk area calculator 144 normalizes the risk potential p.

Next, the target trajectory generator 146 calculates the travelable area DA by using the rule-based model MDL1 defined by the rule-based model data 182 (step S104).

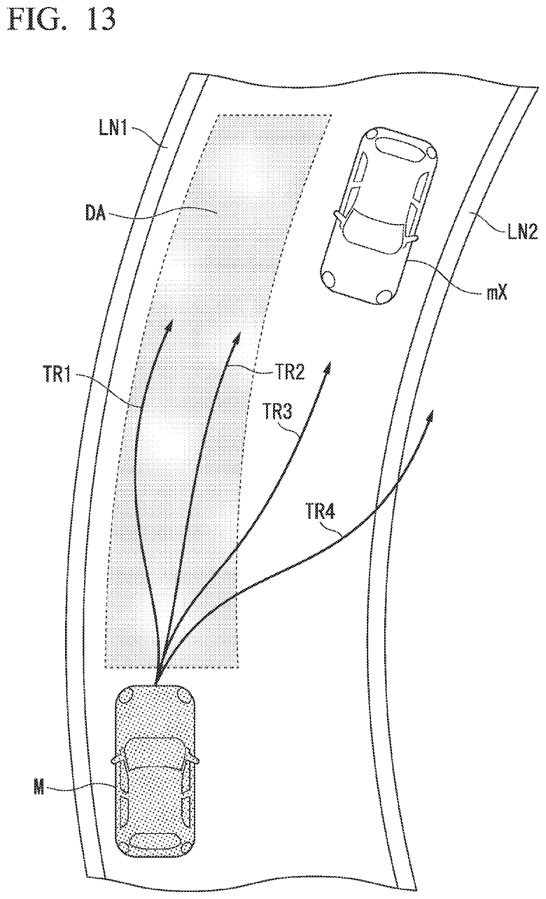

FIG. 12 is a diagram showing an example of a situation that the host vehicle M may encounter. In the shown example, the roadside lines LN1 and LN2, which are a kind of marking lines, are solid white lines and a certain opposite vehicle mX exists in front of the host vehicle M. In such a situation, in order to follow a rule of avoiding the opposite vehicle mX while following a rule of not sticking out from the roadside lines LN1 and LN2, the rule-based model MDL1 outputs, as the travelable area DA, an area obtained by excluding an area, where the opposite vehicle mX is predicted to travel in the future, from an area between the roadside lines LN1 and LN2. The area, where the opposite vehicle mX will travel in the future, may be predicted on the basis of, for example, the position, direction, speed, acceleration, and the like of the opposite vehicle mX.

Returning to the description of the flowchart of FIG. 11, the target trajectory generator 146 generates a plurality of target trajectories TR by using the DNN model MDL2 defined by the DNN model data 184 (step S106).

Next, the target trajectory generator 146 excludes target trajectories TR outside the travelable area DA from the plurality of generated target trajectories TR, and leaves target trajectories TR inside the travelable area DA (step S108).

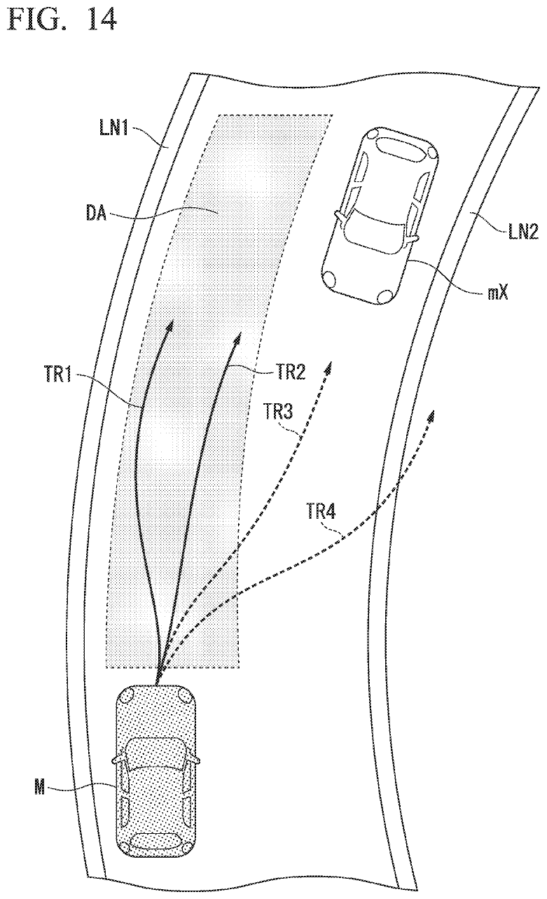

FIG. 13 is a diagram showing an example of the plurality of target trajectories TR. For example, when four DNN models MDL2 are defined by the DNN model data 184, the target trajectory generator 146 inputs the risk area RA calculated by the risk area calculator 144 in the process of S102 to each of the four DNN models MDL2. In response to this, each DNN model MDL2 outputs one target trajectory TR. That is, as shown in FIG. 13, the total four target trajectories TR such as TR1, TR2, TR3, and TR4 are generated.

As described above, the DNN model MDL2 is learned using the teaching data in which the correct target trajectory TR (trajectory that passes through an area where the risk potential p is lower than the threshold value Th) is correlated with the risk area RA as the teaching label. That is, parameters such as the weighting coefficient and the bias component of the DNN model MDL2 are determined using a stochastic gradient descent method and the like such that a different (error) between the target trajectory TR output by the DNN model MDL2 when a certain risk area RA is input and the correct target trajectory TR correlated with the risk area RA as the teaching label decreases.

Therefore, the DNN model MDL2 acts as a kind of stochastic model. The target trajectory TR output by the DNN model MDL2 is expected to be the trajectory that passes through the area where the risk potential p is lower than the threshold value Th. However, although it is considered that the possibility is extremely low, since the DNN model MDL2 stochastically determines the target trajectory TR, it is not possible to deny the possibility of generation of a trajectory that passes through an area where the risk potential p is higher than the threshold value Th. That is, as shown in FIG. 13, there is a possibility of generation of the target trajectory TR3 along which the host vehicle M moves to the movement destination of the opposite vehicle mX or the target trajectory TR4 along which the host vehicle M sticks out from the roadside line LN2 and moves outside the road.

Therefore, the target trajectory generator 146 determines whether the generated each target trajectory TR exists outside or inside the travelable area DA calculated using the rule-based model MDL1, excludes target trajectories TR outside the travelable area DA, and leaves target trajectories TR inside the travelable area DA.

FIG. 14 is a diagram showing an example of excluded target trajectories. In the shown example, among the four target trajectories TR1, TR2, TR3, and TR4, the target trajectories TR3 and TR4 exist outside the travelable area DA. In such a case, the target trajectory generator 146 excludes the target trajectories TR3 and TR4.

Returning to the description of the flowchart of FIG. 11, the target trajectory generator 146 selects an optimal target trajectory TR from one or more target trajectories TR that remains without being excluded (step S110).

For example, the target trajectory generator 146 may evaluate each target trajectory TR from the viewpoint of smoothness of the target trajectory TR and gentleness of acceleration/deceleration, and select a target trajectory TR having the highest evaluation as the optimal target trajectory TR. More specifically, the target trajectory generator 146 may select a target trajectory TR having the smallest curvature κ and the smallest target acceleration c as the optimal target trajectory TR. The selection of the optimal target trajectory TR is not limited thereto and may be performed in consideration of other viewpoints and the like.

Then, the target trajectory generator 146 outputs the optimal target trajectory TR to the second controller 160. In response to this, the second controller 160 controls at least one of the speed and steering of the host vehicle M on the basis of the optimal target trajectory TR output by the target trajectory generator 146 (step S112) In this way, the procedure of the present flowchart ends.

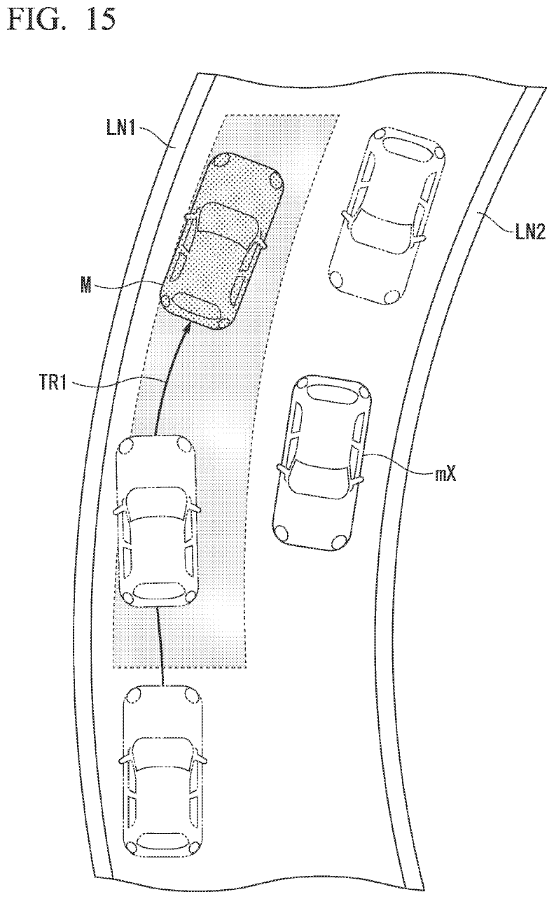

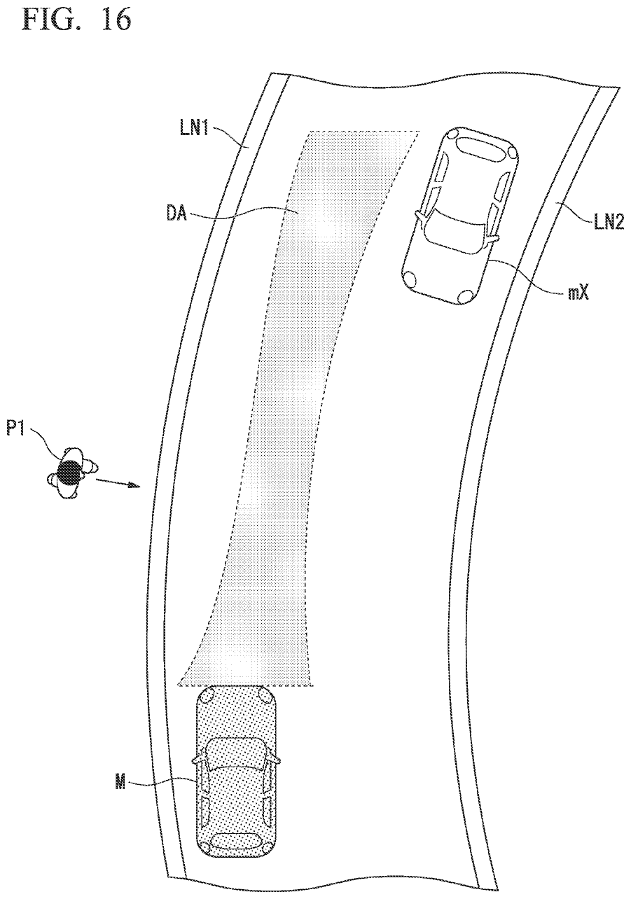

FIG. 15 is a diagram showing an example of a situation in which at least one of the speed and steering of the host vehicle M is controlled on the basis of the target trajectory TR. In the shown example, the target trajectory TR1 inside the travelable area DA is selected as the optimal target trajectory TR and the host vehicle M is moving along the target trajectory TR1. In this way, it is possible to more safely control the driving of the host vehicle M without sticking out from the roadside lines LN1 and LN2 and approaching the opposite vehicle mX more than necessary.

The aforementioned procedure of the present flowchart may be performed even in the case of recognizing other objects, such as pedestrians, in addition to or in place of the roadside lines LN1 and LN2 and the opposite vehicle mX.

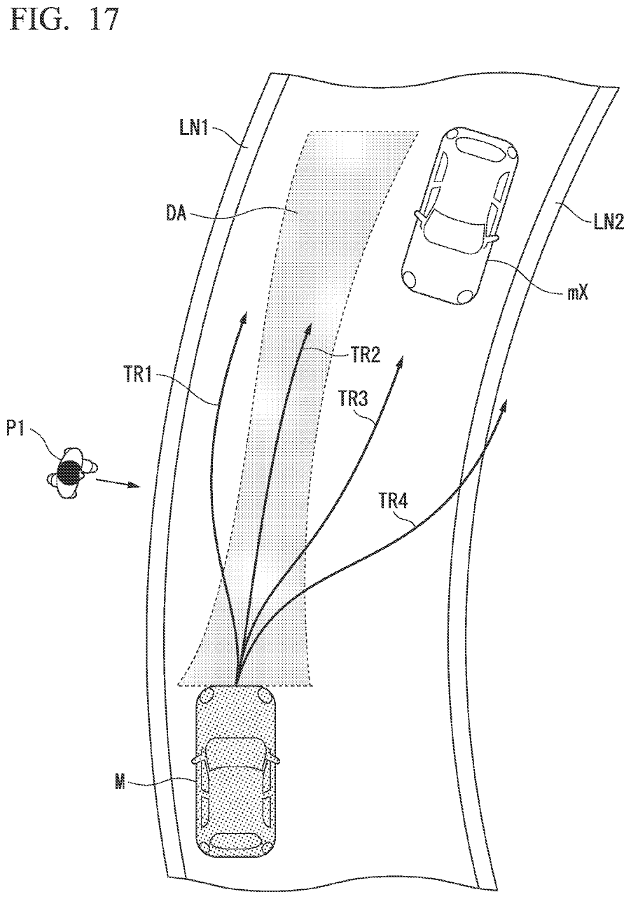

FIG. 16 is a diagram showing another example of a situation that the host vehicle M may encounter. In the shown example, the roadside lines LN1 and LN2, which are solid white lines, the opposite vehicle mX, and a pedestrian P1 are recognized. Although the pedestrian P1 is outside the road, the face, body, and movement direction are toward the road. In such a situation, in order to follow a rule of avoiding the pedestrian P1 as well as the opposite vehicle mX while following a rule of not sticking out from the roadside lines LN1 and LN2, the rule-based model MDL1 outputs, as the travelable area DA, an area obtained by excluding an area where the opposite vehicle mX is predicted to travel in the future and an area where the pedestrian P1 is predicted to travel in the future from an area between the roadside lines LN1 and LN2. The area, where the pedestrian P1 will travel in the future, may be predicted on the basis of, for example, the position, direction, speed, acceleration, and the like of the pedestrian P1.

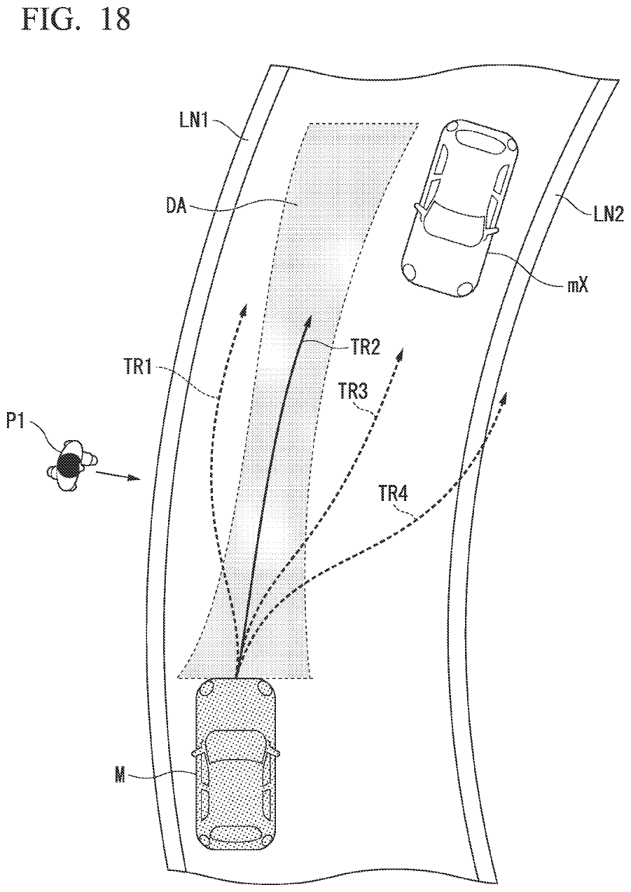

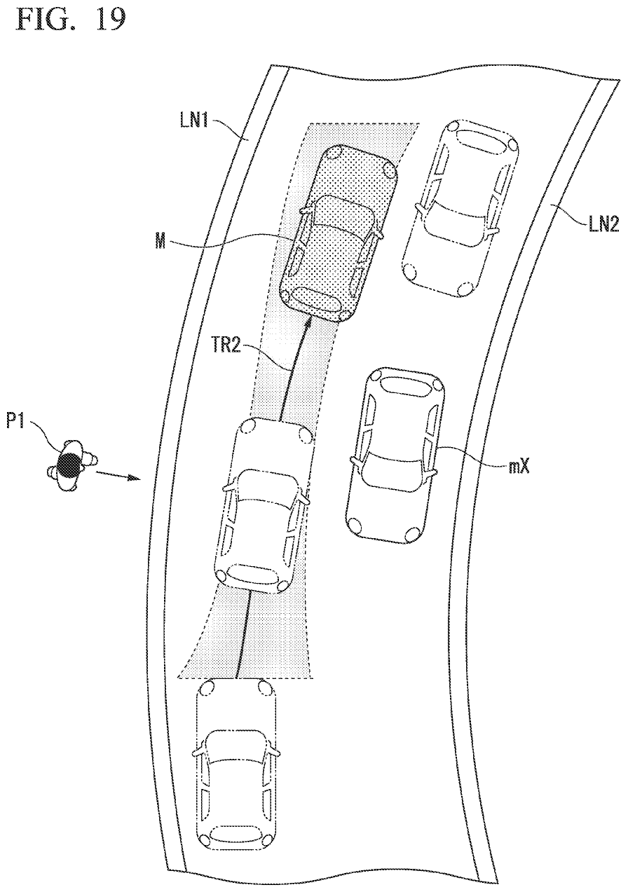

FIG. 17 is a diagram showing another example of the plurality of target trajectories TR. FIG. 18 is a diagram showing another example of excluded target trajectories TR. In the example of FIG. 17, four target trajectories TR are generated similarly to the example of FIG. 13. In a situation where the aforementioned pedestrian P1 does not exist, since the target trajectories TR1 and TR2 exist inside the travelable area DA, they remain without being excluded. On the other hand, in the situation where the pedestrian P1 exists, the travelable area DA is narrowed because the prediction result of the movement destination of the pedestrian P1 is taken into consideration. As a consequence, the target trajectory TR1 exists outside the travelable area DA and the target trajectory TR2 exists inside the travelable area DA. Therefore, the target trajectory generator 146 excludes the target trajectories TR1, TR3, and TR4 outside the travelable area DA and leaves the target trajectory TR2 inside the travelable area DA as is.

FIG. 19 is a diagram showing another example of a situation in which at least one of the speed and steering of the host vehicle M is controlled on the basis of the target trajectory TR. In the shown example, the target trajectory TR2 inside the travelable area DA is selected as the optimal target trajectory TR and the host vehicle M is moving along the target trajectory TR2. In this way, it is possible to more safely control the driving of the host vehicle M without sticking out from the roadside lines LN1 and LN2 and approaching the opposite vehicle mX or the pedestrian P1 more than necessary.

According to the embodiment described above, the automated driving control device 100 recognizes various objects such as marking lines, opposite vehicles, and pedestrians near the host vehicle M, and calculates the risk area RA which is an area of a risk that potentially exists around the objects. Moreover, the automated driving control device 100 calculates the travelable area DA from the states of the recognized objects by using the rule-based model MDL1, and generates a plurality of target trajectories TR from the calculated risk area RA by using the plurality of DNN models MDL2. The automated driving control device 100 excludes target trajectories TR outside the travelable area DA from the plurality of generated target trajectories TR, and leaves target trajectories TR inside the travelable area DA. Then, the automated driving control device 100 automatically controls the driving of the host vehicle M on the basis of the target trajectories TR that remains without being excluded. In this way, it is possible to more safely control the driving of the host vehicle M.

<Modifications of Embodiment>

Hereinafter, modifications of the aforementioned embodiment will be described. The aforementioned embodiment has described the case where the target trajectory generator 146 inputs the risk area RA to each of the plurality of DNN models MDL2 and allows each of the plurality of DNN models MDL2 to output the target trajectory TR; however, the present invention is not limited thereto. For example, the target trajectory generator 146 may input the risk area RA to a certain DNN model MDL2 and allow the DNN model MDL2 to output a plurality of target trajectories TR. In such a case, it is assumed that the DNN model MDL2 is learned on the basis of teaching data in which a plurality of correct target trajectories TR to be output by the DNN model MDL2 are correlated with a certain risk area RA as teaching labels. In this way, the DNN model MDL2 outputs the plurality of target trajectories TR when the certain risk area RA is input.

The aforementioned embodiment has described the case where the target trajectory generator 146 input the risk area RA to the DNN model MDL2 and allows the DNN model MDL2 to output the target trajectory TR; however, the present invention is not limited thereto. For example, the target trajectory generator 146 may input the risk area RA to another machine learning-based model such as a binary tree-type model, a game tree-type model, a model in which low layer neural networks are interconnected like a Boltzman machine, a reinforcement learning model, and a deep reinforcement learning model to cause the machine learning-based model to output the target trajectory TR. The binary tree-type model, the game tree-type model, the model in which low layer neural networks are interconnected like a Boltzman machine, the reinforcement learning model, the deep reinforcement learning model, and the like are other examples of the “first model.”

The aforementioned embodiment has described the case where the target trajectory generator 146 calculates the travelable area DA by using the rule-based model MDL1; however, the present invention is not limited thereto. For example, the target trajectory generator 146 may calculate the travelable area DA by using a model (hereinafter, referred to as a model-based model) generated on the basis of a method called model-based or model-based design. The model-based model is a model that determines (or outputs) the travelable area DA according to objects (including marking lines) near the host vehicle M by using an optimization method such as model predictive control (MPC). The model-based model is another example of the “second model.”

[Hardware Configuration]

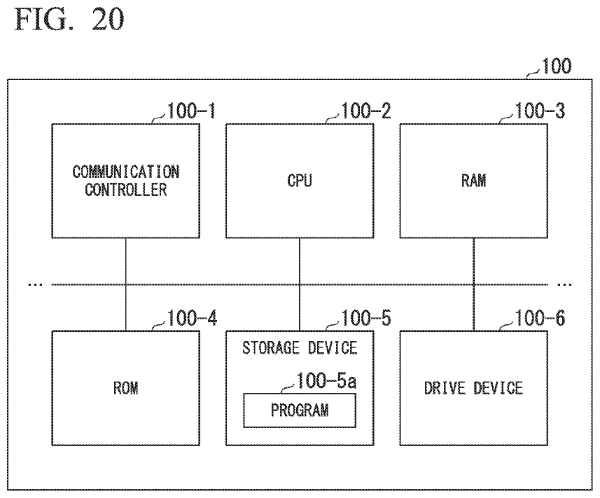

FIG. 20 is a diagram showing an example of a hardware configuration of the automated driving control device 100 of the embodiment. As shown in FIG. 20, the automated driving control device 100 has a configuration in which a communication controller 100-1, a CPU 100-2, a RAM 100-3 used as a working memory, a ROM 100-4 for storing a boot program and the like, a storage device 100-5 such as a flash memory and an HDD, a drive device 100-6, and the like are connected to one another by an internal bus or a dedicated communication line. The communication controller 100-1 communicates with components other than the automated driving control device 100. The storage device 100-5 stores a program 100-5a that is executed by the CPU 100-2. The program is loaded on the RAM 100-3 by a direct memory access (DMA) controller (not shown) and the like, and is executed by the CPU 100-2. In this way, some or all of the first controller and the second controller 160 are implemented.

The aforementioned embodiment can be represented as follows.

A vehicle control device includes at least one or more memories that store a program and at least one or more processors, and the processor executes the program, thereby allowing the vehicle control device to recognize an object near a vehicle, generate one or more target trajectories, along which the vehicle travels, on the basis of the recognized object, automatically control driving of the vehicle on the basis of the generated target trajectories, calculate a travelable area, which is an area where the vehicle is able to travel, on the basis of a state of the recognized object, exclude a target trajectory outside the calculated travelable area from the one or more generated target trajectories, and automatically control the driving of the vehicle on the basis of the target trajectory that remains without being excluded.

Although a mode for carrying out the present invention has been described using the embodiments, the present invention is not limited to these embodiments and various modifications and substitutions can be made without departing from the spirit of the present invention.

What is claimed is:

1. A vehicle control method, the vehicle control method comprising steps of:
recognizing an object near a vehicle;
generating one or more target trajectories, along which the vehicle travels, on the basis of the recognized object;
automatically controlling driving of the vehicle on the basis of the generated target trajectories;
calculating a travelable area, which is an area where the vehicle is able to travel, on the basis of a state of the recognized object;
excluding a target trajectory outside the calculated travelable area from the one or more generated target trajectories; and
automatically controlling the driving of the vehicle on the basis of the target trajectory that remains without being excluded.

2. A vehicle control device comprising:
a recognizer configured to recognize an object near a vehicle;
a generator configured to generate one or more target trajectories, along which the vehicle travels, on the basis of the object recognized by the recognizer; and
a driving controller configured to automatically control driving of the vehicle on the basis of the target trajectories generated by the generator,
wherein the generator calculates a travelable area, which is an area where the vehicle is able to travel, on the basis of a state of the object recognized by the recognizer, and excludes a target trajectory outside the calculated travelable area from the one or more generated target trajectories, and
the driving controller automatically controls the driving of the vehicle on the basis of the target trajectory that remains without being excluded by the generator.

3. The vehicle control device according to claim 2, further comprising:
a calculator configured to calculate a risk area which is an area of risk distributed around the object recognized by the recognizer,
wherein the generator inputs the risk area calculated by the calculator to a model that determines the target trajectory according to the risk area, and generates the one or more target trajectories on the basis of an output result of the model to which the risk area is input.

4. The vehicle control device according to claim 3, wherein the model is a machine-learning-based first model learned to output the target trajectory when the risk area is input.

5. The vehicle control device according to claim 2, wherein the generator calculates the travelable area by using a rule-based or model-based second model that determines the travelable area according to the state of the object.

6. The vehicle control device according to claim 2, wherein the generator selects an optimal target trajectory from the one or more target trajectories from which the target trajectory outside the travelable area is excluded, and
the driving controller automatically controls the driving of the vehicle on the basis of the optimal target trajectory selected by the generator.

7. A non-transitory computer readable storing medium storing a program causing a computer mounted in a vehicle to perform:
recognizing an object near a vehicle;
generating one or more target trajectories, along which the vehicle travels, on the basis of the recognized object;
automatically controlling driving of the vehicle on the basis of the generated target trajectories;
calculating a travelable area, which is an area where the vehicle is able to travel, on the basis of a state of the recognized object;
excluding a target trajectory outside the calculated travelable area from the one or more generated target trajectories; and
automatically controlling the driving of the vehicle on the basis of the target trajectory that remains without being excluded.
